(19) United States
(12) Patent Application Publication
(10) Pub. No.: US 2008/0036329 A1
(43) Pub. Date: Feb. 14, 2008

(54) Motor stator

(75) Inventors: Hung-Chi Chen, Taoyuan Hsien (TW); Te-Tsai Chuang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS INC.

(21) Appl. No.: 11/878,763

(22) Filed: Jul. 26, 2007

(30) Foreign Application Priority Data
Aug. 14, 2006 (TW) 95129725

(51) Int. Cl. H02K 1/16; H02K 3/00

(52) U.S. Cl. 310/216

(57) ABSTRACT

A motor stator includes a yoke, a plurality of winding portions, a plurality of protrusions, and a plurality of arc extensions. The yoke includes a through hole at the center of the yoke. The winding portions are disposed around the exterior and extend outside of the yoke. The protrusion is disposed at an end of each winding portion. Each arc extension is engaged with each protrusion.

### BACKGROUND OF THE INVENTION

1. Field of the Invention

The invention relates to a motor stator.

2. Description of the Related Art

A conventional stator winding of a motor, in particular a stator with concentrated windings, includes a stator with coils wound therearound. FIG. 1 shows a conventional stator 10 which consists of stacked metal sheets. As shown in FIG. 1, the stator 10 includes a yoke 101 having a through hole 102 at the center thereof. A structure for fixing bearings can be disposed in the through hole 102. A plurality of T-shape winding portions 103 are disposed around the yoke 101 as coil poles. The winding portions 103 are wound by enameled wires (not shown) to form winding coils. The centrifugal side of each winding portion 103 includes an arc extension 104. The arc extensions 104 and the yoke 101 are arranged concentrically. A gap d1 is formed between two adjacent arc extensions 104. In general, the gap d1 is required to minimize to avoid the excessive cogging torque.

As motor function improves, the number of winding portions 103 added to produce the pole of the magnetic field is increased. Depending on the requirement of the magnetic flux, the number of coil with each winding portion should be increased or a larger diameter of enameled wire must be used. However, since the gap d1 between two adjacent arc extensions 104 is minimized, it is difficult to wind the enameled wire.

Thus, a stator is disclosed to solve the foregoing problems.

### BRIEF SUMMARY OF THE INVENTION

A motor stator, with a large number of winding coils or a coil with a larger diameter to form wire windings, is provided.

To achieve the described purpose, the stator of the external rotor motor includes a yoke. The center of the yoke serves as a through hole. A plurality of the winding portion is disposed around the exterior of the yoke. The winding portion can match with a detachable arc extension. When winding, the coils are wound on each of the winding portions to form a winding coil and the arc extension is matched to form the stator windings.

Moreover, the detachable arc extension of the stator according to the present invention can be applied to the internal stator windings. The internal stator includes a yoke. The center of the yoke is a through hole. A plurality of winding portions are respectively disposed inside the yoke and extended inwardly. The winding portion can engage with an arc extension. When winding, the coils are respectively wound on each of winding portions to form a winding coil and the arc extension is engaged to form the stator windings.

Furthermore, the stator of the invention further includes a plurality of bobbins which are telescoped onto the winding portion after each of the bobbins is wound. Additionally, the arc extension is engaged with the winding portion to form the stator windings.

A detailed description is given in the following embodiments with reference to the accompanying drawings.

### BRIEF DESCRIPTION OF THE DRAWINGS

The invention will become more fully understood from the subsequent detailed description and the accompanying drawings, which are given by way of illustration only, and thus are not limitative of the present invention, and wherein:

FIG. 1 is schematic view of a conventional stator;

FIG. 2 is a schematic view of a first embodiment of the stator according to the invention;

FIG. 3 is a top view of the stator shown in FIG. 2;

FIG. 4 is a top view of a second embodiment of the stator according to the invention;

FIG. 5A is a top view of a third embodiment of the stator according to the invention;

FIG. 5B is a partial exploded view of the stator shown in FIG. 5A;

FIG. 6A is a top view of a fourth embodiment of the stator according to the invention; and

FIG. 6B is a partial exploded view of the stator shown in FIG. 6A.

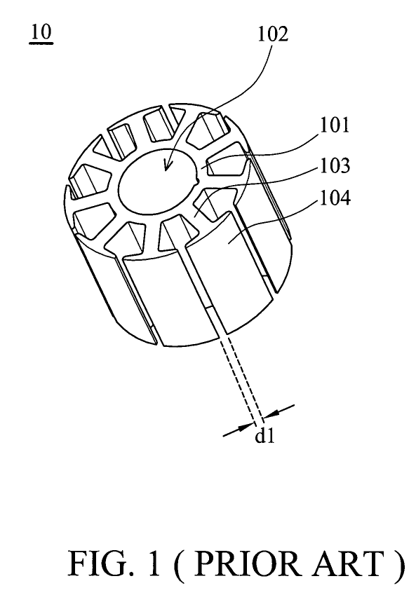

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

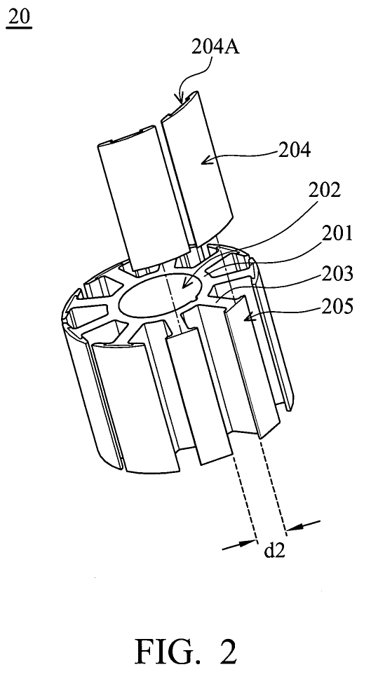

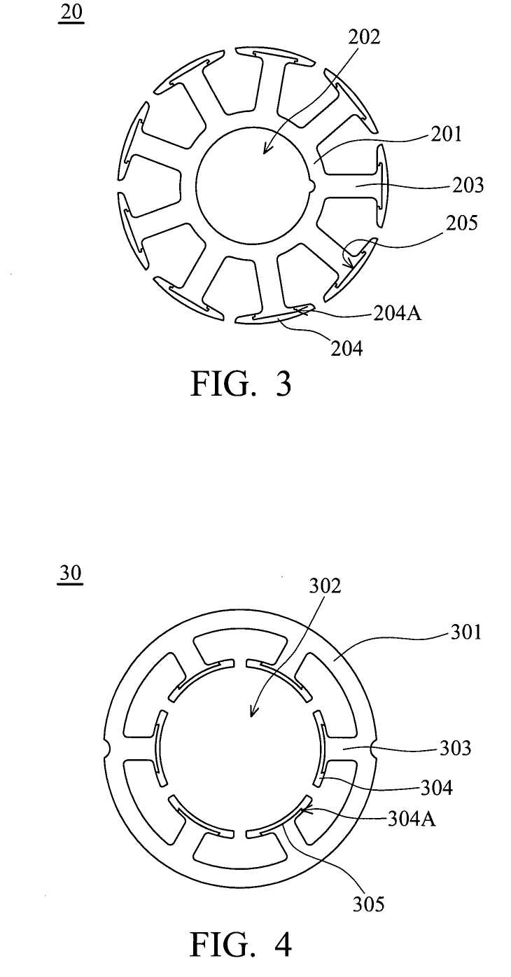

FIG. 2 is a schematic view of a first embodiment of the stator according to the invention. FIG. 3 is a top view of the stator shown in FIG. 2. A stator 20 includes a yoke 201. A through hole 202 is disposed on the center of the yoke 201. Both of the through hole 202 and the yoke 201 are arranged concentrically. A plurality of winding portions 203 are disposed around the yoke 201 and extended outwardly. Each of the winding portions 203 can be wound by coils. An end of the winding portion 203 has a protrusion 205 serving as a stopper to prevent the coils from dropping. An arc extension 204 car be engaged with the protrusion 205 of the winding portion 203. In this embodiment, a dovetailed groove 204A of the arc extension 204 is engaged with the protrusion 205.

In this embodiment, the stator 20 can be applied to an external rotor motor. Preferably, the yoke 201 and the winding portions 203 are formed as a unity by stacked silicon steel sheets. A gap d2 between each two adjacent protrusions 205 is larger than the gap d1 of the conventional stator, and thus, the coil with a larger diameter can be wound thereon. After winding, each of the protrusions 205 is engaged with one arc extension 204 to complete the stator windings.

FIG. 4 is a top view of a second embodiment of the stator according to the invention. A stator 30 includes a yoke 301. A plurality of winding portions 303 are disposed inside the yoke 301 and extended inwardly. Each of the winding portions 303 can be wound by coils to form a winding coil. An end of each winding portion 303 has a protrusion 305 serving as a stopper to prevent the coils from dropping. The protrusion 305 is engaged with an arc extension 304. In this embodiment, a dovetailed groove 304A of the arc extension 304 is engaged with the protrusion 305. A through hole 302 and the yoke 301 are arranged concentrically.

In this embodiment, the stator 30 is applied to an internal rotor motor. Preferably, the yoke 301 of the stator 30 and the winding portions 303 are formed as a unity by stacked silicon steel sheets.

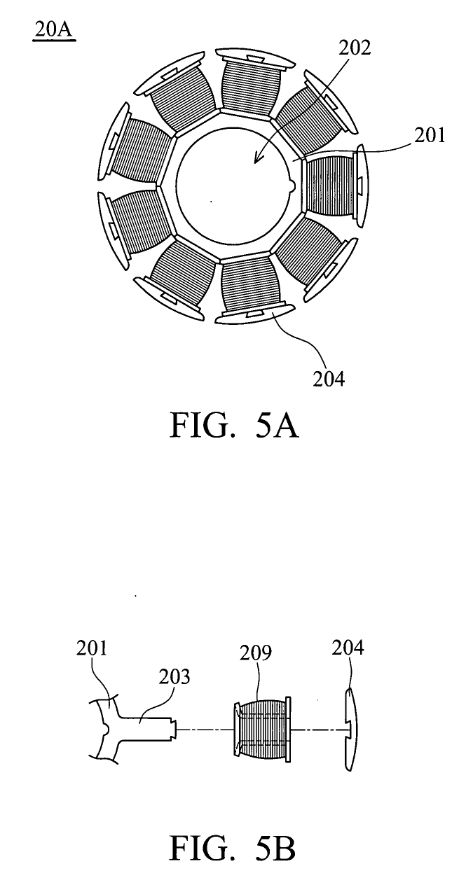

FIG. 5A is a top view of a third embodiment of the stator according to the invention. FIG. 5B is a partial exploded view of the stator shown in FIG. 5A. As shown in FIG. 5A, a stator 20A has the same elements with the stator 20 shown in FIG. 3, and thus the description thereof is omitted for brevity. The stator 20A further includes a plurality of bobbins 209 telescoping the winding portions 203. FIG. 5B shows a part of the yoke 201 engaging with the arc extension 204 after telescoping the winding portions 203 by the bobbins 209. The bobbin 209 is in a form of tube for telescoping the winding portion 203. The center size of the bobbin 209 is substantially the same size as that of the winding portions 203. The exterior surface of the bobbin 209 is wound to form a pre-wound wire coil. The pre-wound wire coil telescopes the winding portion 203 to form a stator 20A shown in FIG. 5A.

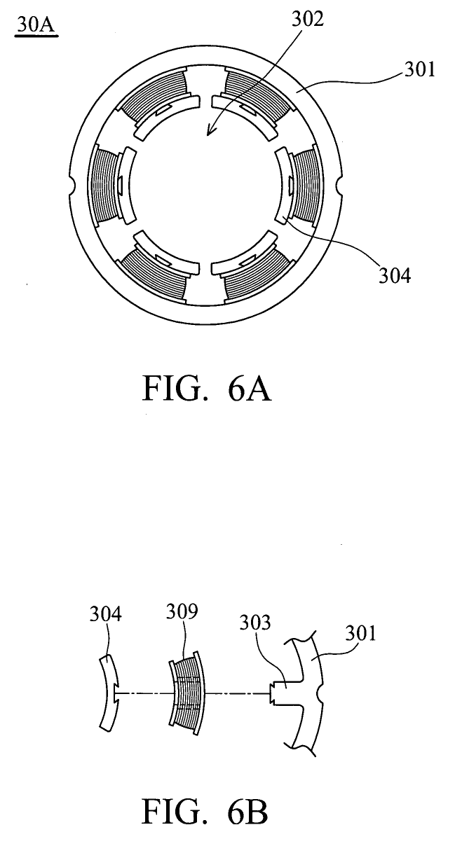

FIG. 6A is a top view of a fourth embodiment of the stator according to the invention. FIG. 6B is a partial exploded view of the stator shown in FIG. 6A. As shown in FIG. 6A, a stator 30A includes the same elements as the stator 30 shown in FIG. 4, and thus the description thereof is omitted for brevity. The stator 30A further includes a plurality of bobbins 309 telescoping the winding portions 303. FIG. 6B shows a part of the yoke 301 engaging with the arc extension 304 after telescoping the winding potions 303 by the bobbins 309. The bobbin 309 is in a form of tube for telescoping the winding portions 303. The center size of the bobbin 309 is substantially the same size as that of the winding portions 303. The exterior surface of the bobbin 309 is wound to form a pre-wound wire coil. Furthermore, the pre-wound wire coil telescopes onto the winding portion 303 to form a stator shown in FIG. 6A.

In the third and the fourth embodiments, the materials of the bobbin 209 and 309 can be plastic or an insulating material, but the materials are not limited those stated, which can be formed a pre-wound coil with the enameled wire.

In the invention, the engaging manner of the arc extension and the protrusion is not limited to the dovetailed groove, other elements for engaging the arc extension with the protrusion can be used.

In summary, the yoke of the stator according to the invention and the winding portions are formed together and the arc extensions are detachable. Compared with the conventional stator, the stator of the invention is sheathed by the arc extensions to form the stator windings after the stator is wound or is telescoped by the bobbins. Thus, wire jams occurring during winding are prevented, manufacturing time is reduced and efficiency is improved.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A motor stator comprising:
a yoke having a through hole at the center of the yoke;
a plurality of winding portions disposed around the exterior of the yoke;
a plurality of protrusions respectively disposed at an end of each of the winding portions; and
a plurality of arc extensions respectively engaged with the protrusions.

2. The motor stator as claimed in claim 1, wherein the yoke, the plurality of winding portions, and the plurality of protrusions are formed as a unity.

3. The motor stator as claimed in claim 1, wherein the arc extension comprises a dovetailed groove to be engaged with the protrusion.

4. The motor stator as claimed in claim 1, wherein the yoke, the plurality of winding portions, the plurality of protrusions, and the plurality of arc extensions are formed by silicon steel sheets.

5. The motor stator as claimed in claim 1, further comprising a coil wound on the winding portion, wherein the arc extension is engaged with the protrusion after the coil is wound on the winding portion.

6. The motor stator as claimed in claim 1, wherein there is a first gap formed between two adjacent protrusions and a second gap formed between two adjacent arc extensions, and wherein the first gap is larger than the second gap.

7. The motor stator as claimed in claim 1, further comprising a bobbin telescoped onto the winding portion.

8. The motor stator as claimed in claim 7, wherein the size of the center of the bobbin is substantially the same as that of the winding portion.

9. The motor stator as claimed in claim 7, further comprising a coil wound on the exterior surface of the bobbin.

10. The motor stator as claimed in claim 7, wherein the bobbin is made of plastic or an insulating material.

11. A motor stator comprising:
a yoke;
a plurality of winding portions disposed inside the yoke;
a plurality of protrusions respectively disposed at an end of each winding portion; and
a plurality of arc extensions respectively engaged with the protrusions.

12. The motor stator as claimed in claim 11, wherein the yoke, the plurality of winding portions, and the plurality of protrusions are formed as a unity.

13. The motor stator as claimed in claim 11, wherein each of the arc extensions further comprises a dovetailed groove to be engaged with each of the protrusions.

14. The motor stator as claimed in claim 11, wherein the yoke, the winding portions, the protrusions, and the arc extensions are formed by silicon steel sheets.

15. The motor stator as claimed in claim 11, further comprising a coil wound on the winding portion, wherein the arc extension is engaged with the protrusion after the coil is wound on the winding portion.

16. The motor stator as claimed in claim 11, further comprising a bobbin telescoped onto winding portion.

17. The motor stator as claimed in claim 16, wherein the size of the center of the bobbin is substantially the same as that of the winding portion.

18. The motor stator as claimed in claim 16, further comprising a coil wound on the bobbin.

19. The motor stator as claimed in claim 16, wherein the bobbin is made of plastic or an insulating material.

20. The motor stator as claimed in claim 11, wherein there is a first gap formed between two adjacent protrusions and a second gap formed between two adjacent arc extensions, and wherein the first gap is larger than the second gap.
